(19) United States
(12) Patent Application Publication
(10) Pub. No.: US 2022/0274230 A1
(43) Pub. Date: Sep. 1, 2022

(54) SUBSTRATE CARRYING MANIPULATOR AND SUBSTRATE CARRYING DEVICE

(71) Applicants: Beijing BOE Display Technology Co., Ltd., Beijing (CN); BOE Technology Group Co., Ltd., Beijing (CN)

(72) Inventors: Xiaogang LIU, Beijing (CN); Junjie JIN, Beijing (CN); Jianye SONG, Beijing (CN)

(21) Appl. No.: 17/504,383

(22) Filed: Oct. 18, 2021

(30) Foreign Application Priority Data
Feb. 26, 2021 (CN) 202120432557.8

(51) Int. Cl. B25B 11/00

(52) U.S. Cl. CPC B25B 11/00

(57) ABSTRACT

Disclosed are a substrate carrying manipulator and a substrate carrying device. The substrate carrying manipulator includes: a bearing frame, having a bearing surface; grabbing assemblies installed on the bearing frame and configured to cooperate with a non-display region of a substrate; and anti-contact assemblies configured to at least provide a gas repulsive force in a direction from the bearing surface to the substrate for a display region of the substrate.

This application claims priority to Chinese Patent Application No. 202120432557.8, filed on Feb. 26, 2021, which is hereby incorporated by reference in its entirety.

### FIELD

The present disclosure relates to the field of display, in particular to a substrate carrying manipulator and a substrate carrying device.

### BACKGROUND

In liquid crystal display products, there is an important production process, namely an oriented film coating process, on a glass substrate. The formation quality of an oriented film is very important. In existing equipment, manipulators are adopted to carry the glass substrate, generally, a plurality of fixing components are adopted to be in contact and fixed with the glass substrate to be moved and transported in the space.

### SUMMARY

The present disclosure discloses a substrate carrying manipulator and a substrate carrying device. In the substrate carrying manipulator, on a bearing frame, grabbing assemblies may be fixedly connected to the part of a non-display region of a substrate, the part of a display region of the substrate is supported by anti-contact assemblies in a non-contact manner and prevented from being in contact with the anti-contact assemblies, and meanwhile, the temperature of the display region of the substrate may not be affected, the coating uniformity of an oriented film is effectively ensured, the formation quality of the oriented film is advantageously improved, and the oriented film is well formed.

The present disclosure provides the following technical solution.

A substrate carrying manipulator, includes: a bearing frame, including a bearing surface; a grabbing assembly installed on the bearing frame and configured to cooperate with a non-display region of a substrate; and an anti-contact assembly installed on the bearing frame and configured to at least provide gas in a direction from the bearing surface to the substrate for a display region of the substrate so as to support the substrate.

In some embodiments, the anti-contact assembly includes: a blowing plate installed on the bearing surface of the bearing frame and corresponding to the display region of the substrate, wherein the blowing plate includes a plurality of vent holes configured to output the gas, and gas outlets of the plurality of vent holes are opposite to the substrate; and a gas supply device configured to provide the gas, and communicating with the plurality of vent holes.

In some embodiments, the blowing plate is installed on the bearing frame through a fixing connection frame.

In some embodiments, the substrate carrying manipulator further includes a gas supply control device in signal connection with the gas supply device and configured to control a gas supply state of the gas supply device.

In some embodiments, the bearing surface of the bearing frame is provided with a plurality of blowing plates evenly spaced and distributed.

In some embodiments, the grabbing assembly includes a fixing part configured to be fixedly connected with the substrate, and the fixing part is installed on the bearing frame through a fixing support.

In some embodiments, the fixing part is installed on the fixing support through an elastic assembly, and the elastic assembly is configured to provide an elastic force in a direction perpendicular to the bearing surface for the fixing part.

In some embodiments, the fixing part includes a vacuum chuck.

In some embodiments, a plurality of grabbing assemblies are disposed, and each corner of the substrate is correspondingly provided with one or more grabbing assemblies.

The present disclosure further provides a substrate carrying device, including any substrate carrying manipulator provided according to the above technical solutions.

### BRIEF DESCRIPTION OF THE DRAWINGS

FIG. 1 is a schematic structural diagram of a substrate carrying manipulator provided by an embodiment of the present disclosure.

FIG. 2 is a schematic structural diagram of a substrate carrying manipulator provided by an embodiment of the present disclosure.

FIG. 3 is a schematic structural diagram in a direction A in FIG. 2.

FIG. 4 is a schematic structural diagram of a grabbing assembly and a bearing frame provided by an embodiment of the present disclosure.

FIG. 5 is a schematic structural diagram of a grabbing assembly provided by an embodiment of the present disclosure.

FIG. 6 is a schematic structural diagram of an anti-contact assembly provided by an embodiment of the present disclosure.

FIG. 7 is a schematic structural diagram of a blowing plate provided by an embodiment of the present disclosure.

Icons: 1—bearing frame; 2—grabbing assembly; 3—anti-contact assembly; 4—substrate; 11—bearing surface; 21—fixing part; 22—fixing support; 23—elastic assembly; 31—blowing plate; 32—fixing connection frame; 311—vent hole.

### DETAILED DESCRIPTION OF THE EMBODIMENTS

The embodiments of the present disclosure will be clearly and fully described in combination with the accompanying drawings of the embodiments of the present disclosure. Apparently, it is to be understood that the described embodiments are some, but not all, embodiments of the present disclosure. Based on the described embodiments of the present disclosure, all other embodiments attainable by those ordinary skilled in the art without involving any inventive effort are within the scope of the present disclosure.

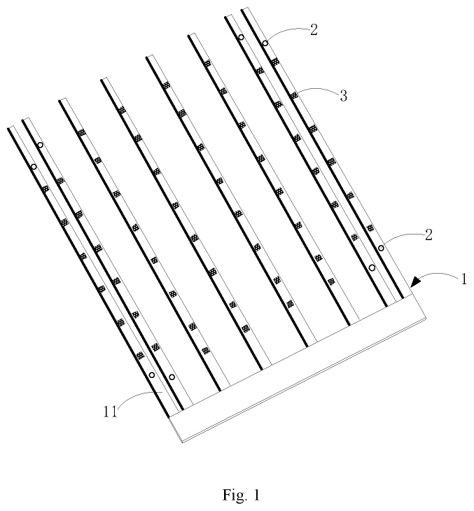

As shown in FIG. 1 to FIG. 3 and FIG. 6, an embodiment of the present disclosure provides a substrate carrying manipulator, including: a bearing frame 1, having a bearing surface 11; one or more grabbing assemblies 2 installed on the bearing frame 1 and configured to cooperate with a non-display region of a substrate 4; and one or more anti-contact assemblies 3 installed on the bearing frame and configured to at least provide a repulsive force in a direction from the bearing surface to the substrate for a display region of the substrate.

In the above substrate carrying manipulator, the bearing frame 1 is a grabbing end which is configured to carry the substrate, the bearing frame 1 has the bearing surface, and the substrate is installed on the bearing surface of the bearing frame 1. In some embodiments, the grabbing assemblies 2 are installed on the bearing frame 1 and correspond to the non-display region of the substrate, and in a case that the grabbing assemblies 2 are in contact and fixed with the substrate, the grabbing assemblies 2 are connected and fixed to the non-display region around the substrate to avoid being in contact with the part where the substrate is coated with an oriented film, which will not affect the oriented film with which the substrate is coated, the substrate is stably fixed on the bearing frame 1, and the bearing frame 1 may conveniently carry the substrate. Since the grabbing assemblies 2 are fixedly connected to the part of the non-display region of the substrate, that is, the grabbing assemblies 2 are connected to a periphery part of the substrate, the substrate is supported to a certain height, and there is an interval between the substrate and the bearing surface. In order to avoid recession in the middle of the substrate and ensure that the substrate is flat, the anti-contact assemblies 3 are disposed, and may be fixed to the bearing frame 1, the anti-contact assemblies 3 at least correspond to the display region of the substrate and are in the direction perpendicular to the bearing surface, in a case that the substrate is fixed to the grabbing assemblies 2, a surface, facing the bearing surface, of the substrate is higher than a surface, facing the substrate, of the anti-contact assemblies 3, that is, there is a certain interval D (an interval D as shown in FIG. 3) between the substrate and the anti-contact assemblies, so that a certain space is provided between the substrate and gas outlets of the anti-contact assemblies, a certain interval is conveniently formed between the anti-contact assemblies 3 and the substrate; in a case that the substrate is installed on the grabbing assemblies, the substrate is disposed on the upper portions of the grabbing assemblies, the middle of the substrate will sag due to gravity, the anti-contact assemblies may provide gas for the display region of the substrate, that is, the anti-contact assemblies blow the gas to the substrate, the gas may provide a repulsive force for the substrate, the middle part of the substrate is prevented from sagging, the substrate is supported, the display region of the substrate is effectively prevented from being in contact with components below, the substrate is flat on the whole, and good formation of the oriented film is facilitated.

In some embodiments, the interval D between the substrate and the anti-contact assemblies may be set as 0.8 mm to 1.5 mm, such as 0.8 mm, 1 mm, 1.5 mm, etc. The gas is a gas with a certain pressure, the anti-contact assemblies 3 blow the gas to the substrate in the direction from the bearing surface to the substrate, the substrate is supported by gas flow, non-contact gas floating support for the display region of the substrate is achieved, the situation that in the prior art, temperature conduction of the contact support to a display region of a substrate affects the formation of an oriented film on the substrate is avoided, the supportability is good, and the substrate is prevented from being affected. The display region of the substrate is supported by the gas, so that not only can the flatness of the substrate be ensured, but also the good uniformity of the oriented film in the display region of the substrate is ensured, and the formation quality is ensured.

In the above substrate carrying manipulator, on the bearing frame 1, the grabbing assemblies 2 may be fixedly connected to the part of the non-display region of the substrate, the part of the display region of the substrate is supported by the anti-contact assemblies 3 in a non-contact manner to achieve a better support function, and meanwhile, the temperature of the oriented film on the display region of the substrate may not be affected, the coating uniformity of the oriented film is effectively ensured, the formation quality of the oriented film is advantageously improved, and the oriented film is well formed.

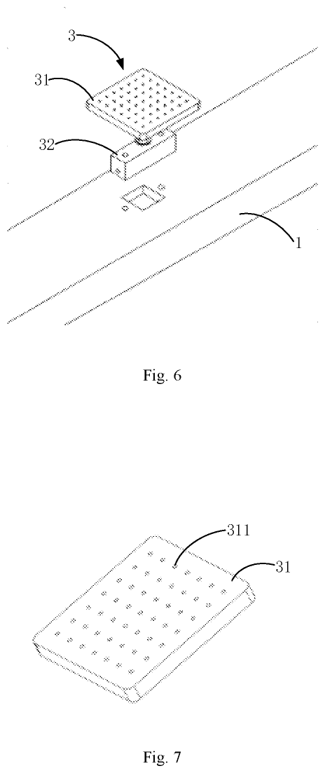

In some embodiments, as shown in FIG. 6, in the above substrate carrying manipulator, an anti-contact assembly 3 includes: a blowing plate 31 installed on the bearing surface of the bearing frame 1 and corresponding to the display region of the substrate. The bearing surface is provided with an opening corresponding to the blowing plate 31. The blowing plate 31 is installed on the opening of the bearing surface, and installation of the blowing plate 31 and arrangement of other ventilation components are facilitated. As shown in FIG. 7, the blowing plate 31 has a plurality of vent holes 311 configured to output gas, and gas outlets of the plurality of vent holes 311 are opposite to the substrate, and the substrate may be blown and supported. The plurality of vent holes on the blowing plate 31 are evenly spaced and distributed, the stability of support can be improved, where the quantity of the vent holes on the blowing plate may be set to be 49, 50, etc. A diameter of each vent hole may be set to be 0.5 mm, 0.6 mm, etc. The anti-contact assembly 3 also includes a gas supply device configured to provide gas. The gas supply device communicates with the vent holes. The gas supply device and the vent holes may be connected through a gas conveying pipeline. The plurality of vent holes on the same blowing plate 31 are connected to the gas supply device through one gas conveying pipeline. A pressure regulating valve may be disposed on the gas conveying pipeline to adjust the pressure of the gas ejected from the blowing plate 31, so that the support force to the substrate is adjusted, the use flexibility is high, and the substrate is better supported.

In some embodiments, as shown in FIG. 6, in the above substrate carrying manipulator, a blowing plate 31 is installed on the bearing frame 1 through a fixing connection frame 32, and the connection stability is good. The above gas conveying pipeline passes through the corresponding opening on the bearing frame 1 to be connected to the blowing plate 31 to provide gas for the vent holes of the blowing plate 31.

In some embodiments, the above substrate carrying manipulator further includes a gas supply control device in signal connection with the gas supply device and configured to control a gas supply state of the gas supply device. The gas supply state of the gas supply device is controlled by the gas supply control device, so that the gas supply device may be automatically controlled to facilitate the adjustment of the gas supply state of the gas supply device. In some embodiments, the pressure regulating valve on the gas conveying pipeline may be in signal connection with the gas supply control device, the gas supply control device may also control the pressure regulating valve, by controlling the pressure regulating valve, the pressure of the gas output by the gas conveying pipeline is adjusted so as to adjust the support force to the substrate, and the support for the substrate is more conveniently adjusted.

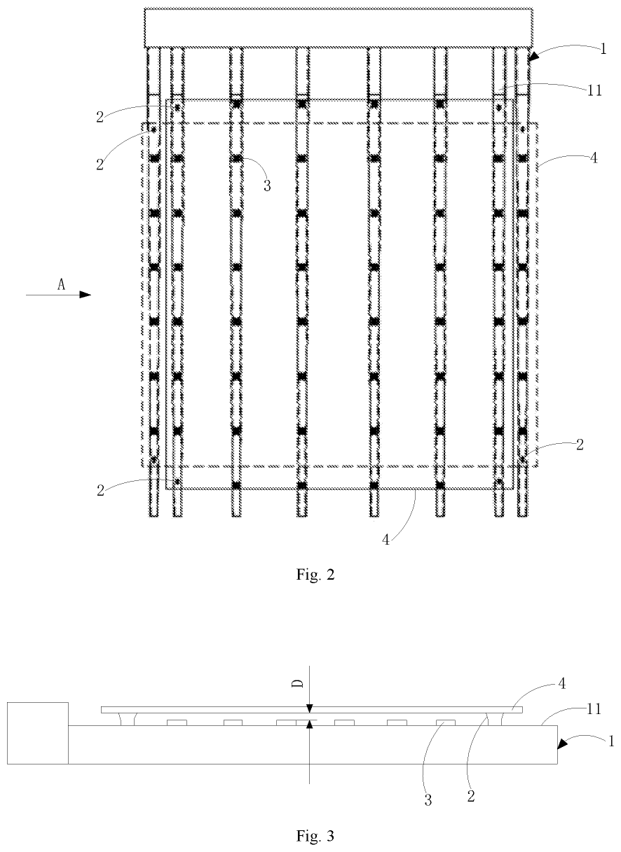

In some embodiments, as shown in FIG. 2 and FIG. 6, in the above substrate carrying manipulator, a plurality of blowing plates 31 evenly spaced and distributed are disposed on the bearing surface of the bearing frame 1 so as to better support the substrate, the support uniformity for the substrate is increased, the flatness of the substrate is advantageously ensured, and the oriented film on the substrate is well formed; and each blowing plate 31 is connected to the gas supply device through the gas conveying pipeline, the support effect for each blowing plate 31 is achieved by adjusting the gas supply state of the blowing plate 31 through the gas supply device, specifically, a variety of combined controls may be performed on part of the blowing plates 31 of the plurality of blowing plates 31 to facilitate matching with substrates of different sizes, or the substrates are matched in different directions on the bearing frame 1, for example, the bearing surface of the bearing frame 1 has a first direction and a second direction, the first direction is perpendicular to the second direction, when the long side of the substrate is placed parallel to the first direction, it may be said that the substrate is placed horizontally (the substrate shown by the dotted line in FIG. 1), when the long side of the substrate is parallel to the second direction, it may be said that the substrate is placed transversely (the substrate shown by the solid line in FIG. 1), so that regardless of whether the substrate is disposed transversely or longitudinally on the bearing frame 1, the blowing plate 31 corresponding to the display region of the substrate may be controlled for ventilation so as to support the substrate.

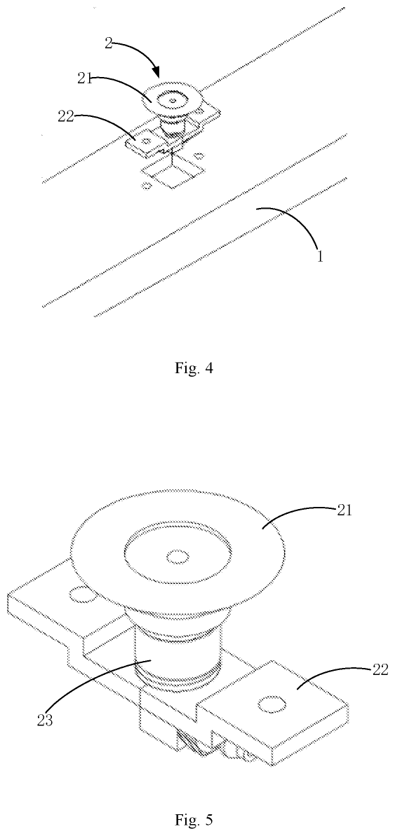

In some embodiments, as shown in FIG. 4, in the above substrate carrying manipulator, each grabbing assembly 2 includes a fixing part 21 configured to be fixedly connected with the substrate, the fixing part 21 is installed on the bearing frame 1 through a fixing support 22, the fixing part 21 is in direct contact and fixed with the substrate, and the substrate is fixed, operation is convenient, the substrate may be fixed on the bearing frame 1 for convenient carrying, and a certain support function is also achieved.

In some embodiments, as shown in FIG. 5, in the above substrate carrying manipulator, the fixing part 21 is installed on the fixing support 22 through an elastic assembly 23, the elastic assembly 23 is configured to provide an elastic force in a direction perpendicular to the bearing surface for the fixing part 21, the fixing part 21 is installed on the fixing support 22 through the elastic assembly 23, the elastic assembly 23 may have a certain elastic expansion and contraction in the direction perpendicular to the bearing surface, after the fixing part 21 fixes the substrate, the anti-contact assemblies 3 blow the substrate for support, and the elastic assembly 23 may buffer the fixing part 21 to a certain extent to ensure the stable and flat support for the substrate. In some embodiments, the elastic assembly 23 may include a spring.

In some embodiments, in the above substrate carrying manipulator, each fixing part may be set as a vacuum chuck, and the vacuum chuck is configured to suck and fix the substrate, operation is simple, and stability is good. In some embodiments, the vacuum chuck generates a certain suction force on the substrate to achieve fixed connection with the substrate. In order to ensure that the substrate is fixedly connected to the vacuum chuck, the suction force of the chuck is controlled to be greater than the support force generated by the blowing of the anti-contact assemblies on the substrate.

In some embodiments, as shown in FIG. 1 and FIG. 2, in the above substrate carrying manipulator, a plurality of grabbing assemblies 2 are disposed, each corner of the substrate corresponds to one grabbing assembly 2, and the grabbing assemblies 2 are disposed corresponding to the non-display region of the substrate. In some embodiments, the grabbing assemblies 2 may be disposed corresponding to the corners of the substrate. For example, the substrate is generally rectangular, the positions, corresponding to the four corners of the substrate, of the bearing frame may be each provided with one grabbing assembly 2, so that the grabbing assemblies 2 are fixedly connected to the corners of the substrate. In some embodiments, in view of the different placement positions of the substrate on the bearing frame 1, two groups of grabbing assemblies 2 may be disposed, each group of grabbing assemblies 2 includes four grabbing assemblies 2, wherein for the positions of the substrate placed transversely, four grabbing assemblies 2 are disposed on the bearing frame 1 and respectively correspond to the four corners of the substrate placed transversely; for the positions of the substrates placed longitudinally, another four grabbing assemblies 2 are disposed on the bearing frame 1 and respectively correspond to the four corners of the substrate placed longitudinally; and it should be noted that the specific positions of the grabbing assemblies 2 may be set according to actual needs, and as long as the grabbing assemblies are disposed corresponding to the non-display region of the substrate, the substrate may be stably fixed on the bearing frame 1.

The present disclosure further provides a substrate carrying device, including any substrate carrying manipulator provided in the above embodiments. The substrate carrying device includes a mechanical arm in transmission connection with the substrate carrying manipulator, and the mechanical arm may move the substrate carrying manipulator in the space. In the above substrate carrying device, on the bearing frame 1 of the substrate carrying manipulator, the grabbing assemblies 2 may be fixedly connected to the non-display region of the substrate, the display region of the substrate is supported by the anti-contact assemblies 3 in a non-contact manner, a better support effect is achieved, the temperature of the display region of the substrate will not be affected, the coating uniformity of the oriented film is effectively ensured, the formation quality of the oriented film is advantageously improved, and the oriented film is formed well.

What is claimed is:

1. A substrate carrying manipulator, comprising:
a bearing frame, comprising a bearing surface;
a grabbing assembly installed on the bearing frame and configured to cooperate with a non-display region of a substrate; and
an anti-contact assembly installed on the bearing frame and configured to at least provide a repulsive force in a direction from the bearing surface to the substrate for a display region of the substrate.

2. The substrate carrying manipulator according to claim 1, wherein the anti-contact assembly comprises:
a blowing plate installed on the bearing surface of the bearing frame and corresponding to the display region of the substrate, wherein the blowing plate comprises a plurality of vent holes configured to output gas, and gas outlets of the plurality of vent holes are opposite to the substrate; and
a gas supply device configured to provide the gas, and communicating with the plurality of vent holes.

3. The substrate carrying manipulator according to claim 2, wherein the blowing plate is installed on the bearing frame through a fixing connection frame.

4. The substrate carrying manipulator according to claim 2, further comprising a gas supply control device in signal connection with the gas supply device and configured to control a gas supply state of the gas supply device.

5. The substrate carrying manipulator according to claim 2, wherein the bearing surface of the bearing frame is provided with a plurality of blowing plates evenly spaced and distributed.

6. The substrate carrying manipulator according to claim 1, wherein the grabbing assembly comprises a fixing part fixedly connected with the substrate, and the fixing part is installed on the bearing frame through a fixing support.

7. The substrate carrying manipulator according to claim 6, wherein the fixing part is installed on the fixing support through an elastic assembly, and the elastic assembly is configured to provide an elastic force in a direction perpendicular to the bearing surface for the fixing part.

8. The substrate carrying manipulator according to claim 7, wherein the fixing part comprises a vacuum chuck.

9. The substrate carrying manipulator according to claim 1, wherein a plurality of grabbing assemblies are disposed, and each corner of the substrate is correspondingly provided with one or more grabbing assemblies.

10. The substrate carrying manipulator according to claim 2, wherein a plurality of grabbing assemblies are disposed, and each corner of the substrate is correspondingly provided with one or more grabbing assemblies.

11. The substrate carrying manipulator according to claim 3, wherein a plurality of grabbing assemblies are disposed, and each corner of the substrate is correspondingly provided with one or more grabbing assemblies.

12. A substrate carrying device, comprising a substrate carrying manipulator, wherein the substrate carrying manipulator comprises:
a bearing frame, comprising a bearing surface;
a grabbing assembly installed on the bearing frame and configured to cooperate with a non-display region of a substrate; and
an anti-contact assembly installed on the bearing frame and configured to at least provide a repulsive force in a direction from the bearing surface to the substrate for a display region of the substrate.

13. The substrate carrying device according to claim 12, wherein the anti-contact assembly comprises:
a blowing plate installed on the bearing surface of the bearing frame and corresponding to the display region of the substrate, wherein the blowing plate comprises a plurality of vent holes configured to output gas, and gas outlets of the plurality of vent holes are opposite to the substrate; and
a gas supply device configured to provide the gas, and communicating with the plurality of vent holes.

14. The substrate carrying device according to claim 13, wherein the blowing plate is installed on the bearing frame through a fixing connection frame.

15. The substrate carrying device according to claim 13, further comprising a gas supply control device in signal connection with the gas supply device and configured to control a gas supply state of the gas supply device.

16. The substrate carrying device according to claim 13, wherein the bearing surface of the bearing frame is provided with a plurality of blowing plates evenly spaced and distributed.

17. The substrate carrying device according to claim 12, wherein the grabbing assembly comprises a fixing part fixedly connected with the substrate, and the fixing part is installed on the bearing frame through a fixing support.

18. The substrate carrying device according to claim 17, wherein the fixing part is installed on the fixing support through an elastic assembly, and the elastic assembly is configured to provide an elastic force in a direction perpendicular to the bearing surface for the fixing part.

19. The substrate carrying device according to claim 18, wherein the fixing part comprises a vacuum chuck.

20. The substrate carrying device according to claim 12, wherein a plurality of grabbing assemblies are disposed, and each corner of the substrate is correspondingly provided with one or more grabbing assemblies.
